(19) United States
(12) Patent Application Publication
(10) Pub. No.: US 2024/0042649 A1
(43) Pub. Date: Feb. 8, 2024

(54) TREATMENT ELEMENT FOR TREATING MATERIAL BY MEANS OF A SCREW MACHINE

(71) Applicant: Coperion GmbH, Stuttgart (DE)

(72) Inventors: Johannes HEYN, Altbach (DE); Mareike TABELING, Stuttgart (DE); Johannes DONNER, Stuttgart (DE); Dirk KYRION, Sternenfels (DE)

(73) Assignee: Coperion GmbH, Stuttgart (DE)

(21) Appl. No.: 18/364,966

(22) Filed: Aug. 3, 2023

(30) Foreign Application Priority Data
Aug. 5, 2022 (EP) 22 188 918.1

(51) Int. Cl. B29B 7/42

(52) U.S. Cl. CPC B29B 7/429; B29B 7/421

(57) ABSTRACT

A treatment element for treating material by means of a screw machine comprises a conveying section and a melting section. The melting section is arranged downstream of the conveying section in a conveying direction and is connected in one piece with the conveying section. This reduces wear and increases the service life.

### CROSS-REFERENCES TO RELATED APPLICATION

This application claims the priority of European Patent Application, Serial No. EP 22 188 918.1, filed Aug. 5, 2022, the content of which is incorporated herein by reference in its entirety as if fully set forth herein.

### FIELD OF THE INVENTION

The invention relates to a treatment element for treating material by means of a screw machine. The invention further relates to a screw machine comprising such a treatment element.

### BACKGROUND OF THE INVENTION

From EP 1 508 424 A1 (corresponds to US 2005/0041521 A1), a screw-type extruding machine is known which comprises a casing and profiled shafts with treatment elements arranged thereon. In a feed zone, conveying elements or screw elements are arranged as treatment elements on the profiled shafts. In a mixing and kneading zone, which is formed in a conveying direction downstream of the feed zone, kneading blocks are arranged as treatment elements on the profiled shafts for melting and homogenizing the material to be processed. The kneading blocks each comprise several kneading disks formed in one piece with each other. In a pressure build-up zone formed downstream of the mixing and kneading zone, screw elements are again arranged as treatment elements on the profiled shafts.

The material to be processed is melted in the mixing and kneading zone. There, the treatment elements and the associated shafts are subjected to high loads, which cause high wear at the treatment elements, the shafts and the housing and reduce the service life thereof.

### SUMMARY OF THE INVENTION

It is an object of the invention to provide a treatment element for treating material by means of a screw machine, which treatment element has low wear and a long service life.

This object is achieved by a treatment element for treating material by means of a screw machine comprising a conveying section and a melting section, which is arranged downstream of the conveying section in a conveying direction, and which is connected in one piece with the conveying section. The treatment element is used for treating and/or melting material, in particular plastic material, by means of a screw machine. The conveying section comprises in particular a conveying element or screw element to convey the material to be treated. The melting section comprises in particular at least one kneading disk. The at least one kneading disk serves to introduce energy into the material to be treated and/or to melt the material to be treated. The treatment element is designed in particular as a combination treatment element, since the one-piece design of the conveying section and the melting section combines the functions of conveying and melting. In particular, the treatment element comprises a profiled through-bore for fastening the treatment element on a profiled shaft of a screw machine.

Due to the one-piece configuration of the conveying section and the melting section, no gap can occur between the conveying section and the melting section into which material or material melt could penetrate, despite high loads. Due to the one-piece configuration, the specific load, i.e. the load per unit area, on the treatment element as well as an associated profiled shaft is thus reduced. Furthermore, the stiffness of the treatment element is increased at the critical passage between the conveying section and the melting section, so that relative movements and deformations of the treatment element are reduced during the operation of the screw machine. This reduces wear and increases the service life. In particular, the risk of breakage of the shafts can be reduced.

A treatment element in which the melting section comprises a number N of kneading disks, wherein: 1≤N≤7, in particular 2≤N≤6, and in particular 3≤N≤5, ensures low wear and a long service life. The melting section is formed in one piece. In particular, a plurality of kneading disks are connected to each other in one piece. If the melting section has a plurality of interconnected kneading disks, loads occurring in the melting section during the operation of the screw machine are distributed over a plurality of kneading disks. The respective kneading disk can be of single-flight to four-flight design. Preferably, the kneading disk has two or three flights. The kneading disks of the melting section can be configured to be geometrically identical and/or geometrically different.

A treatment element in which the melting section comprises at least two kneading disks which are arranged one after the other in the conveying direction, and a respective first side and/or a respective second side of the at least two kneading disks have an offset angle c relative to one another, wherein: 0°≤c≤90°, in particular 15°≤c≤75°, and in particular 30°≤c≤60°, ensures low wear and a long service life. Each kneading disk has a first side which is directed upstream with respect to the conveying direction and a second side which is directed downstream with respect to the conveying direction. Two kneading disks that are arranged immediately one after the other have an offset angle c on their first sides and/or on their second sides relative to one another, so that the arrangement of the kneading disks promotes the conveying of the material. The dwell time of the material in the melting section and thus the energy input or melting on the one hand and the load on the other hand can be adjusted by the offset angle c.

A treatment element in which the melting section comprises at least one kneading disk which is twisted between a first side and a second side ensures low wear and a long service life. Each kneading disk has a first side which is directed upstream with respect to the conveying direction and a second side which is directed downstream with respect to the conveying direction. The first side is offset from the second side by a twist angle d, so that the kneading disk is twisted from the first side to the second side. If the treatment element is arranged on an associated profiled shaft of a screw machine, this reduces the load on the respective treatment element. At least two intersecting housing bores are formed in a housing of a multi-shaft worm machine so that the housing forms at least one approximate triangle region. The approximate triangle region is the tapered housing region which is formed by the intersecting at least two housing bores. The twist angle prevents the material to be processed from being trapped in the approximate triangle region. The twist angle creates a conveying effect. The twist angle creates an axial impulse acting on the material and thus a preferential direction, so that lower forces act on the material in the approximate triangle region and thus also on the treatment element, resulting in less stress and less damage. Furthermore, the twist angle reduces the volume of the material that is enclosed in the approximate triangle region at the same time. By lowering the forces acting in the approximate triangle region, the stress, in particular a bending moment and/or a torsional moment, acting on the treatment element and the associated shaft is reduced. Vibrations of the treatment element shafts of the multi-shaft worm machine can be reduced so that wear and damage to the housing and/or to the treatment elements is reduced and/or is avoided on the shafts.

A treatment element in which the at least one kneading disk has a twist angle d between the first side and the second side, wherein: 0°<d≤30°, in particular 5°≤d≤25°, and in particular 10°≤d≤20°, ensures low wear and a long service life. If the melting section comprises several kneading disks, individual kneading disks or all kneading disks may have a twist angle d. The twist angle of the kneading disks may be identical and/or different.

A treatment element in which the at least one kneading disk has a pitch P_{A} and an outer diameter D_{AA}, wherein: 5≤P_{A}/D_{AA}≤10, in particular 6≤P_{A}/D_{AA}≤9, and in particular 7≤P_{A}/D_{AA}≤8, ensures low wear and a long service life. Due to the twist of the at least one kneading disk, the respective profile of the kneading disk defines a helix in the conveying direction. This helix defines the pitch P_{A} at one full revolution, i.e. an angle of 360°, in the conveying direction. The pitch P_{A} is also referred to as the lead. In a multi-shaft worm machine, the ratio of the pitch P_{A} to the outer diameter D_{AA} reduces the load in the approximate triangle region between adjacent treatment elements that are arranged in pairs. The twist angle d results from the pitch P_{A} and a width L_{A} of the respective kneading disk.

A treatment element in which the melting section comprises at least two kneading disks which are arranged one after the other in the conveying direction, and a first side of a kneading disk arranged downstream has an offset angle e relative to a second side of a kneading disk arranged upstream, wherein: 5°≤e≤70°, in particular 10°≤e≤55°, and in particular 15°≤e≤40°, ensures low wear and a long service life. Each kneading disk has a first side which is directed upstream with respect to the conveying direction and a second side which is directed downstream with respect to the conveying direction. Two kneading disks that are arranged immediately one after the other are connected to each other between the second side of the kneading disk that is arranged upstream and the first side of the kneading disk that is arranged downstream. The offset angle e is formed between the second side of the kneading disk that is arranged upstream and the first side of the kneading disk that is arranged downstream. In particular, the following applies to the offset angle e: e=b−d, wherein b denotes an offset angle between first sides and/or second sides of two successive kneading disks and d denotes a twist angle of the kneading disk that is arranged upstream. The offset angle e can promote the conveying of the material. This can influence the dwell time of the material in the melting section. The offset angle e influences or adjusts the energy input and the melting on the one hand and the load on the treatment element on the other hand

A treatment element in which the melting section comprises at least one kneading disk having a width L_{A} and an outer diameter D_{AA}, wherein: 0.1≤L_{A}/D_{AA}≤0.4, in particular 0.15≤L_{A}/D_{AA}≤0.35, and in particular 0.2≤L_{A}/D_{AA}≤0.3, ensures low wear and a long service life. The width L_{A} is related to the conveying direction. The number of kneading disks and/or the ratio of the width L_{A} to the outer diameter D_{AA} influences on the one hand the energy input into the material and the melting of the material and on the other hand the load on the treatment element. The more kneading disks the melting section comprises and/or the wider the respective kneading disk, the stiffer and sturdier the treatment element.

A treatment element in which the melting section comprises at least one kneading disk having a tip chamfer ensures low wear and a long service life. The respective kneading disk has several edges. A first circumferential edge is disposed between a first side, which is directed upstream with respect to the conveying direction, and a circumferential side. Correspondingly, a second circumferential edge is arranged between a second side, which is directed downstream with respect to the conveying direction, and the circumferential side. Third edges may be arranged on the circumferential side and run transversely to the first edge and/or the second edge. For example, in the case of multi-flight kneading disks, edges run between the respective crest region and the adjacent flank region. The tip chamfer reduces the volume of the respective kneading disk so that, in return, the free volume in a housing bore of a screw machine is increased. By increasing the free volume, the load of the material on the treatment element and the associated profiled shaft is reduced. In particular, the free volume in the approximate triangle region is increased, so that the load in the approximate triangle region is reduced. The tip chamfer is in particular designed as a bevel and/or rounding. Preferably, the tip chamfer extends over at least 25%, in particular at least 50% and in particular at least 75% of the length of the respective edge. Preferably, the circumferential side of the respective kneading disk can be formed without an edge. Such a profile of a kneading disk is also called an involute profile or the kneading disk is called an involute kneading disk. Such profiles are disclosed, for example, in WO 2011/039 016 A1, to which reference is made.

A treatment element in which the conveying section has a pitch P_{F} and an outer diameter D_{AF}, wherein: 0.75≤P_{F}/D_{AF}≤2, in particular 1≤P_{F}/D_{AF}≤1.75, and in particular 1.25≤P_{F}/ D_{AF}≤1.5, ensures low wear and a long service life. Preferably, the conveying section comprises a conveying element or a screw element. The profile of the conveying section or conveying element is in particular designed to be single- to four-flight, preferably double-flight or three-flight. The profile of the conveying section or conveying element defines a helix in the conveying direction. The helix defines a pitch P_{F} at one full revolution, i.e. at an angle of 360°. This pitch is also referred to as the lead. The conveying effect of the conveying section is adjusted by the ratio of the pitch P_{F} to the outer diameter D_{AF}. The conveying effect determines the amount of material that is fed to the melting section per unit of time. The ratio of the pitch P_{F} to the outer diameter D_{AF} is thus used to adjust the load in the transition region between the conveying section and the melting section. The conveying section can have an Erdmenger profile, a thrust edge profile and/or an involute profile.

A treatment element in which the conveying section has a length L_{F} and a pitch P_{F}, wherein: 0.2≤L_{F}/P_{F}≤1.5, in particular 0.3≤L_{F}/P_{F}≤1.2, and in particular 0.4≤L_{F}/P_{F}≤0.9, ensures low wear and a long service life. The length L_{F} is related to the conveying direction. The profile of the conveying section defines a helix in the conveying direction. The helix has a pitch P_{F} at one full revolution, i.e. at an angle of 360°. The pitch P_{F} is also referred to as the lead. The conveying effect of the conveying section is adjusted by the ratio of the length L_{F}to the pitch P_{F}. As a result, the load in the transition region between the conveying section and the melting section is adjusted.

A treatment element in which the conveying section and the melting section have an offset angle b relative to one another, wherein: 0°≤b≤90°, in particular 5°≤b≤45°, and in particular 10°≤b≤15°, ensures low wear and a long service life. The conveying effect and the load in the transition region between the conveying section and the melting section are adjusted by the offset angle b. The melting section has in particular a first side which is directed upstream with respect to the conveying direction. In contrast, the conveying section has in particular a second side which is directed downstream with respect to the conveying direction. The first side of the melting section is in particular connected in one piece with the second side of the conveying section, wherein the offset angle b is formed between the second side of the conveying section and the first side of the melting section. Preferably, the offset angle b is formed between a second side of a conveying element of the conveying section and a first side of a kneading disk of the melting section. The following applies in particular to the offset angle b: 0°≤b≤5°, in particular 0°≤b≤1°, and in particular b=0°.

A treatment element comprising a supporting section which is arranged downstream of the melting section in the conveying direction and is connected in one piece with the melting section ensures low wear and a long service life. The supporting section reduces radial movements of the treatment element. This reduces wear and possible damage and increases the service life of the treatment element. The supporting section ensures the use of the melting section in accordance with its function. In addition, the stiffness of the treatment element is increased. The loads acting on the treatment element are better distributed over the length of the treatment element.

Preferably, the supporting section has a first side which is directed upstream with respect to the conveying direction and is connected to the melting section. Preferably, the melting section has a second side which is directed downstream with respect to the conveying direction and is connected to the supporting section. An offset angle f is formed between the second side of the melting section and the first side of the supporting section, wherein in particular: −90°≤f≤90°, in particular −45°≤f≤45°, in particular −15°≤f≤15°, in particular −5°≤f≤5°, in particular −1°≤f≤1°, and in particular f=0°. Positive offset angles f are offset angles against the predefined direction of rotation. Positive offset angles have a promoting effect. In contrast, negative offset angles f are offset angles in the predefined direction of rotation. Negative offset angles have a restraining effect. Depending on the material to be processed, conveying or backpressure of the material may be desired after melting. Preferably, the offset angle f is formed between a second side of a kneading disk of the melting section and a first side of a kneading disk of the supporting section. Preferably, the offset angle f is equal to the offset angle e.

A treatment element in which the supporting section comprises at least one kneading disk, which is in particular untwisted, ensures low wear and a long service life. The supporting section comprises a number M of kneading disks, wherein in particular: 1≤M≤4, and in particular 2≤M≤3. The kneading disks can be of single-flight to four-flight design, preferably the kneading disks are of two-flight or three-flight design. The kneading disks can be of identical and/or different design.

Preferably, the supporting section comprises at least two kneading disks which are arranged immediately one after the other in the conveying direction. Each of the kneading disks comprises a first side which is directed upstream with respect to the conveying direction and a second side which is directed downstream with respect to the conveying direction. An offset angle g is formed between the first sides and/or the second sides of the at least two kneading disks, wherein in particular: 0°≤g≤180°, in particular 15°≤g≤120°, and in particular 30°≤g≤90°.

The at least one kneading disk is preferably untwisted or not twisted. Preferably, each kneading disk of the supporting section or all kneading disks of the supporting section are untwisted or not twisted. A twist angle is therefore 0°. Each kneading disk has a first side which is directed upstream with respect to the conveying direction and a second side which is directed downstream with respect to the conveying direction. The first side and the second side of the respective kneading disk are thus congruent and/or have no twist angle to each other.

A treatment element in which the supporting section comprises at least one kneading disk having a width L_{S} and an outer diameter D_{AS}, wherein: 0.05≤L_{S}/D_{AS}≤0.5, in particular 0.1≤L_{S}/D_{AS}≤0.35, and in particular 0.15≤L_{S}/D_{AS}≤0.2, ensures low wear and a long service life. The width L_{S} is related to the conveying direction. If the supporting section has several kneading disks, the kneading disks can have an identical width L_{S} and/or different widths L_{S}. Preferably, the width L_{S} of the last kneading disk of the supporting section as seen in the conveying direction is smaller than the width L_{S} of an upstream kneading disk of the supporting section. As a result, an undesirably large width can be avoided if a downstream kneading disk of a further treatment element is arranged without an offset angle.

A treatment element in which the melting section has an outer diameter D_{AA} and the supporting section has an outer diameter D_{AS}, wherein D_{AA}<D_{AS}, and/or in which the conveying section has an outer diameter D_{AF} and the supporting section has an outer diameter D_{AS}, wherein D_{AF}<D_{AS}, ensures low wear and a long service life. The melting section and/or the conveying section is reduced in diameter compared to the supporting section. Due to the fact that the outer diameter D_{AA} and/or the outer diameter D_{AF} is reduced compared to the outer diameter D_{AS}, the load on the treatment element in the region of the melting section and/or the conveying section is reduced. At the same time, the supporting section provides a high supporting effect due to the larger outer diameter D_{AS}, so that radial movements of the treatment element are reduced.

The outer diameter D_{AA} of the melting section can be constant along the length of the melting section or in relation to successively arranged kneading disks of the melting section and/or increase in the conveying direction and/or decrease in the conveying direction. The outer diameter D_{AA}can change continuously and/or discontinuously along the length of the melting section.

The outer diameter D_{AF} of the conveying section can be constant along the length of the conveying section or in relation to successively arranged conveying elements of the conveying section and/or increase in the conveying direction and/or decrease in the conveying direction. The outer diameter D_{AF} can change continuously and/or discontinuously along the length of the conveying section.

Preferably, a spacer element is arranged between the conveying section and the melting section and/or between the melting section and the supporting section. The spacer element is connected in one piece with the conveying section and the melting section or with the melting section and the supporting section. Preferably, a spacer element is arranged between at least two kneading disks of the melting section and/or between at least two kneading disks of the supporting section. The spacer element is connected to the kneading disks in one piece. The spacer element is circular in cross-section, for example, or is configured in accordance with the profile of the conveying section and/or of the melting section and/or of the supporting section. The following applies for an outer diameter D_{AD} of the spacer element: D_{AD}<D_{AF} and/or D_{AD}<D_{AA} and/or D_{AD}<D_{AS}. Preferably, the following applies to a width L_{D} of the respective spacer element with respect to the conveying direction: 0<L_{D}/D_{AD}≤0.1, and in particular 0.01≤L_{D}/D_{AD}≤0.02. Due to the spacer elements, the at least two treatment element shafts can rotate freely with respect to one another in the at least two housing bores despite manufacturing clearances. An inner diameter of the spacer element is preferably larger than an inner diameter of the at least two kneading disks.

It is a further object of the invention to provide a screw machine for treating material which has low wear and a long service life.

This object is achieved by a screw machine for treating material, comprising a housing, at least one housing bore formed in the housing, and at least one treatment element shaft which is arranged in the at least one housing bore, wherein the at least one treatment element shaft comprises at least one treatment element according to the invention. The advantages of the screw machine according to the invention correspond to the advantages of the described treatment element. Preferably, the screw machine has at least one treatment element shaft which comprises a profiled shaft. At least one treatment element according to the invention is arranged on the profiled shaft. An associated treatment element shaft is rotatably arranged in each housing bore.

Preferably, the at least one treatment element is arranged in a melting zone and/or a homogenizing zone of the screw machine. High loads act in the melting zone and/or the homogenizing zone, which are reduced by the at least one treatment element according to the invention. Preferably, the at least one treatment element according to the invention comprises at least one kneading disk and is arranged in the melting zone and/or the homogenizing zone such that the at least one treatment element according to the invention forms a first treatment element with a kneading disk with respect to the conveying direction. In other words, preferably no treatment elements not according to the invention with a kneading disk are arranged upstream of the at least one treatment element according to the invention in the melting zone and/or the homogenizing zone.

Preferably, the screw machine is designed as a multi-shaft worm machine, in particular as a twin-shaft worm machine. In particular, the multi-shaft worm machine has at least two housing bores which are formed in the housing. The at least two housing bores intersect each other. As a result, the at least two housing bores form the shape of a horizontal figure eight, in particular in cross-section. The multi-shaft worm machine comprises at least two treatment element shafts, which in particular each comprise a profiled shaft, on each of which at least one treatment element according to the invention is arranged. The multi-shaft worm machine is designed to rotate in the same direction, i.e. with at least two treatment element shafts rotating in the same directions of rotation. Preferably, the at least two treatment element shafts are designed and/or arranged to closely mesh with each other. Preferably, each treatment element shaft has at least one treatment element according to the invention, which are arranged at the same positions with respect to the conveying direction.

The at least one housing bore has a diameter D. The conveying section has an outer diameter D_{AF}, wherein in particular: 0.8≤D_{AF}/D<1, in particular 0.9≤D_{AF}/D≤0.99, and in particular 0.95≤D_{AF}/D≤0.98.

The melting section has an outer diameter D_{AA}, wherein in particular: 0.8≤D_{AA}/D<1, in particular 0.9≤D_{AA}/D≤0.99, and in particular 0.95≤D_{AA}/D≤0.98.

The supporting section has an outer diameter D_{AS}, wherein in particular: 0.95≤D_{AS}/D<1, in particular 0.98≤D_{AS}/D≤0.998, and in particular 0.99≤D_{AS}/D≤0.995.

Preferably, the following applies: D_{AF}/D<D_{AS}/D and/or D_{AA}/D<D_{AS}/D.

Further features, advantages and details of the invention will be apparent from the following description of several embodiments.

### BRIEF DESCRIPTION OF THE DRAWINGS

FIG. 1 shows a partially sectioned apparatus for treating material using a multi-shaft worm machine,

FIG. 2 shows a partially sectioned top view onto the apparatus in FIG. 1,

FIG. 3 shows a sectional illustration of the multi-shaft worm machine along section line III-III in FIG. 2,

FIG. 4 shows a perspective view of two treatment elements arranged in pairs next to each other according to a first embodiment example, which are part of the multi-shaft worm machine in FIG. 1,

FIG. 5 shows a first side view of one of the treatment elements in FIG. 4,

FIG. 6 shows a second side view of the treatment element in FIG. 5,

FIG. 7 shows a sectional view through the treatment element along section line VII-VII in FIG. 5,

FIG. 8 shows a perspective view of two treatment elements arranged in pairs next to each other according to a second embodiment example,

FIG. 9 shows a side view of one of the treatment elements in FIG. 8, and

FIG. 10 shows a sectional view through the treatment element along section line X-X in FIG. 9.

### DESCRIPTION OF THE PREFERRED EMBODIMENTS

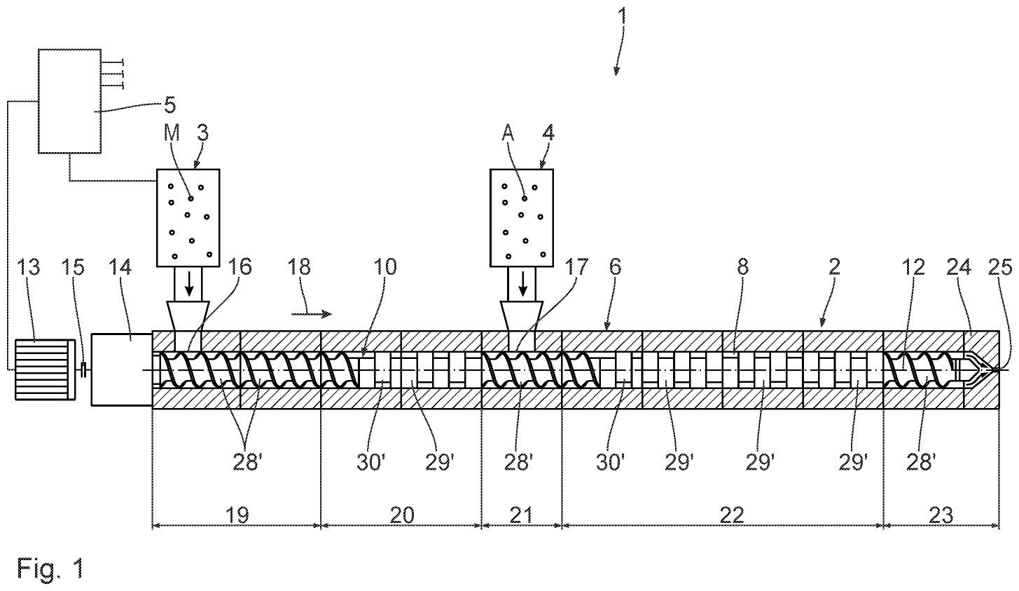

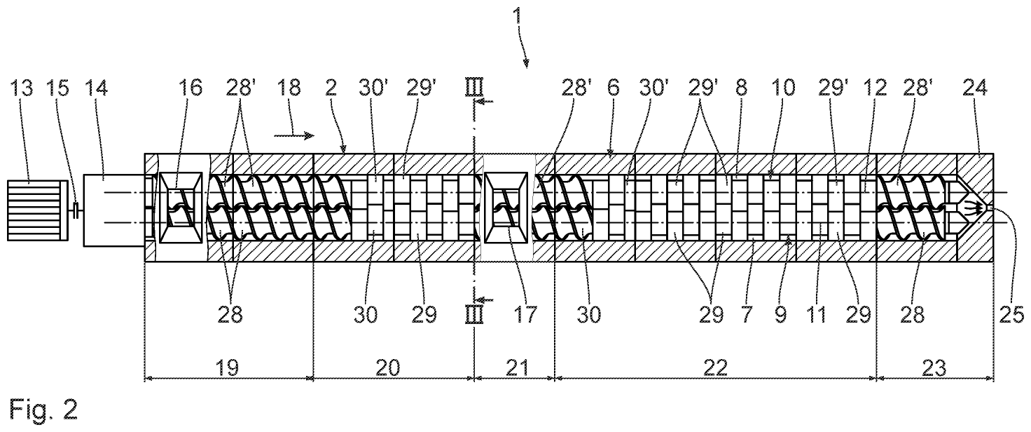

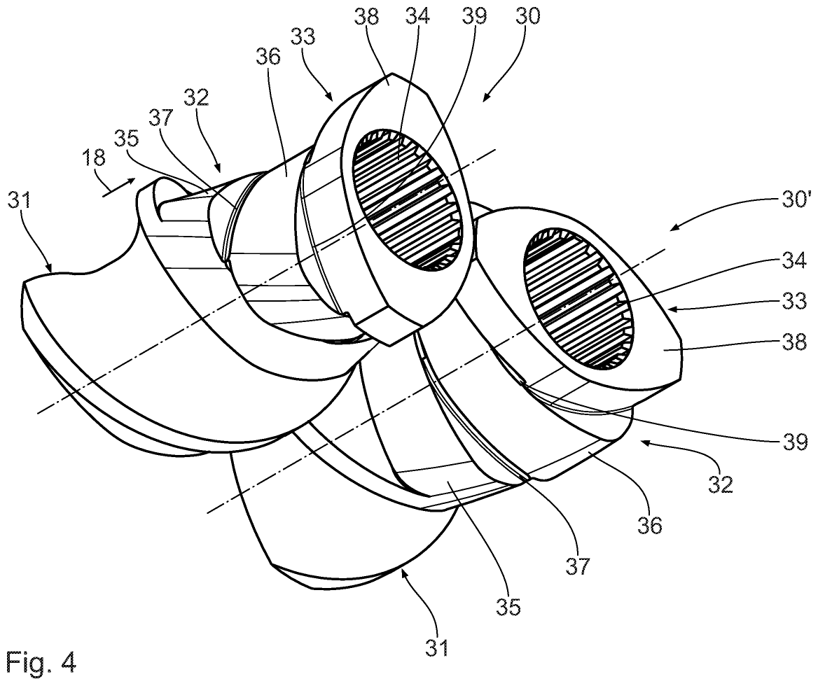

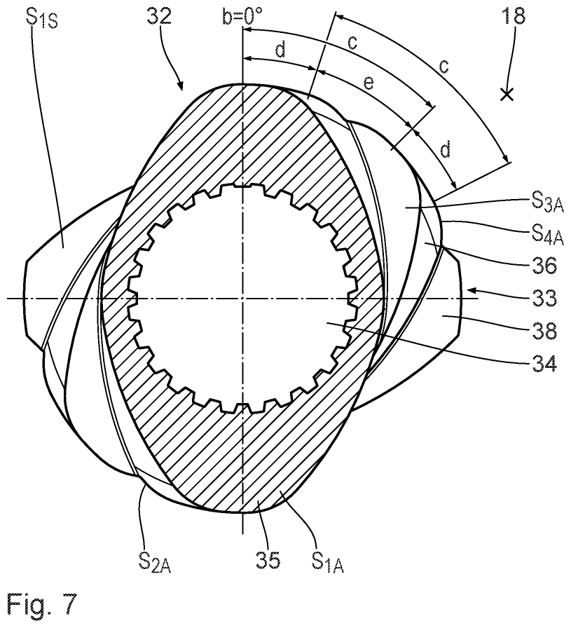

A first embodiment example of the invention is described below with reference to FIGS. 1 to 7. An apparatus 1 for treating and preparing material M comprises a multi-shaft worm machine 2, a first dosing installation 3, a second dosing installation 4 and a control installation 5. The material M is in particular a plastic material.

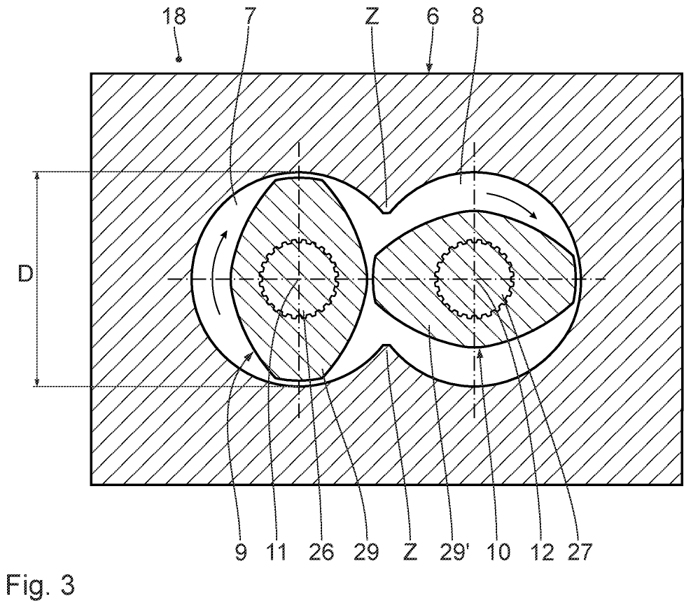

The multi-shaft worm machine 2 comprises a housing 6 in which two interpenetrating housing bores 7, 8 are formed. The housing bores 7, 8 have the shape of a horizontal figure eight in cross-section. The two interpenetrating housing bores 7, 8 form approximate triangle regions Z. The approximate triangle regions Z are the tapered regions of the housing 6. The approximate triangle regions Z are illustrated in FIG. 3. Treatment element shafts 9, 10 are arranged in the housing bores 7, 8 so as to be rotatable about associated axes of rotation 11, 12. The treatment element shafts 9, 10 can be driven in rotation in the same direction, i.e. in the same directions of rotation, by means of a drive motor 13 via a transfer gear 14. A coupling 15 is arranged between the drive motor 13 and the transfer gear 14.

A first feed opening 16 and a second feed opening 17 are formed in the housing 6, which open into the housing bores 7, 8. The second feed opening 17 is arranged downstream of the first feed opening 16 in a conveying direction 18. The first dosing installation 3 opens into the first feed opening 16 and serves for feeding the material M. The second dosing installation 4 opens into the second feed opening 17 and serves for feeding at least one additive A. The first dosing installation 3 and/or the second dosing installation 4 is designed, for example, as a gravimetric dosing installation.

The multi-shaft worm machine 2 comprises, in succession in the conveying direction 18, a first feed zone 19, a melting zone 20, a second feed zone 21, a homogenizing zone 22 and a discharge zone 23. The housing 6 is closed off in the discharge zone 23 by a discharge plate 24 which forms a discharge opening 25.

The treatment element shafts 9, 10 each comprise a profiled shaft 26, 27, on which screw elements 28, 28′, kneading elements 29, 29′ and treatment elements 30, 30′ according to the invention are arranged in pairs next to each other. In the first feed zone 19, screw elements 28, 28′ are arranged on the shafts 26, 27 in a torque-transmitting manner In the melting zone 20, treatment elements 30, 30′ and kneading elements 29, 29′ according to the invention are arranged on the shafts 26, 27 in a torque-transmitting manner In the second feed zone 21, screw elements 28, 28′ are arranged on the shafts 26, 27 in a torque-transmitting manner In the homogenizing zone 22, treatment elements 30, 30′ and kneading elements 29, 29′ according to the invention are arranged on the shafts 26, 27 in a torque-transmitting manner. In the discharge zone 23, screw elements 28, 28′ are arranged on the shafts 26, 27 in a torque-transmitting manner The screw elements 28, 28′ and/or the kneading elements 29, 29′ are of conventional design. The screw elements 28, 28′ and/or the kneading elements 29, 29′ and/or the treatment elements 30, 30′ according to the invention are in particular of two-flight design. The kneading elements 29, 29′ are designed, for example, as individual kneading disks and/or as kneading blocks comprising a plurality of kneading disks that are connected to one another in one piece.

The treatment elements 30, 30′ according to the invention are identical. Only one treatment element 30 is described below.

The treatment element 30 is used for treating and/or melting material M. The treatment element 30 comprises a conveying section 31, a melting section 32 and a supporting section 33. The melting section 32 is arranged downstream of the conveying section 31 in the conveying direction 18. The conveying section 31 and the melting section 32 are connected to each other in one piece. The supporting section 33 is arranged downstream of the melting section 32 in the conveying direction 18. The melting section 32 and the supporting section 33 are connected to each other in one piece.

The treatment element 30 has a profiled bore 34 which passes through the conveying section 31, the melting section 32 and the supporting section 33. The profiled bore 34 serves to arrange the treatment element 30 in form-fit manner on the associated profiled shaft 26, so that a torque can be transmitted from the shaft 26 to the treatment element 30.

The conveying section 31 is designed as a conveying element or screw element. The conveying section 31 comprises a first side S_{1F}, which is directed upstream in the conveying direction 18, and a second side S_{2F}, which is directed downstream in the conveying direction 18. The conveying section 31 has a two-flight profile. The conveying section 31 has an outer diameter D_{AF} and a length L_{F} in the conveying direction 18. Further, the conveying section 31 defines a helix S_{F} which has a pitch P_{F} at one full revolution, i.e. at an angle of 360°. The pitch P_{F} is also referred to as the lead. For a ratio P_{F}/D_{AF} of the pitch P_{F} to the outer diameter D_{AF}, the following applies in particular: 0.75≤P_{F}/D_{AF}≤2, in particular 1≤P_{F}/D_{AF}≤1.75, and in particular 1.25≤P_{F}/D_{AF}≤1.5.

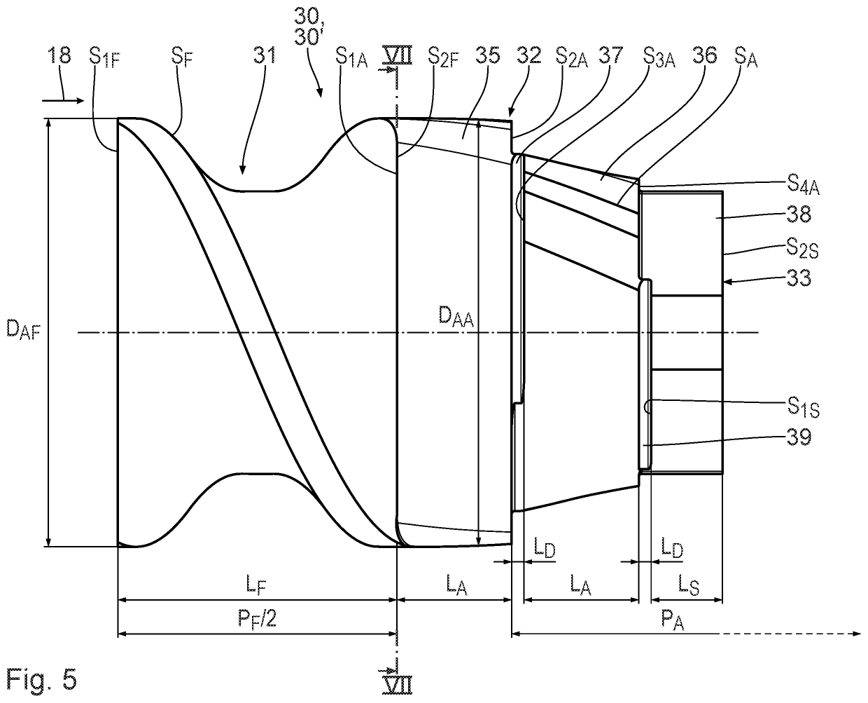

Furthermore, for a ratio L_{F}/P_{F} of the length L_{F} to the pitch P_{F}, in particular: 0.2 ≤L_{F}/P_{F}≤1.5, in particular 0.3≤L_{F}/P_{F}≤1.2, and in particular 0.4≤L_{F}/P_{F}≤0.9. For the embodiment example in FIG. 5, for example: L_{F}/P_{F}=0.5.

The melting section 32 comprises a number N of kneading disks, wherein the following generally applies: 1≤N≤7, in particular 2≤N≤6, and in particular 3≤N≤5. For the embodiment example according to FIGS. 1 to 7, the following applies by way of example: N=2. The melting section 32 thus comprises a first kneading disk 35 and a second kneading disk 36. A first spacer element 37 is arranged between the first kneading disk 35 and the second kneading disk 36. The spacer element 37 is arranged downstream of the first kneading disk 35 in the conveying direction 18. The second kneading disk 36 is arranged downstream of the spacer element 37 in the conveying direction 18. The first kneading disk 35, the spacer element 37 and the second kneading disk 36 are formed in one piece with each other.

The first kneading disk 35 has a first side S_{1A} which is directed upstream in the conveying direction 18. Further, the first kneading disk 35 has a second side S_{2A} which is directed downstream in the conveying direction 18. Accordingly, the second kneading disk 36 has a first side S_{3A} which is directed upstream in the conveying direction 18 and a second side S_{4A} which is directed downstream in the conveying direction 18.

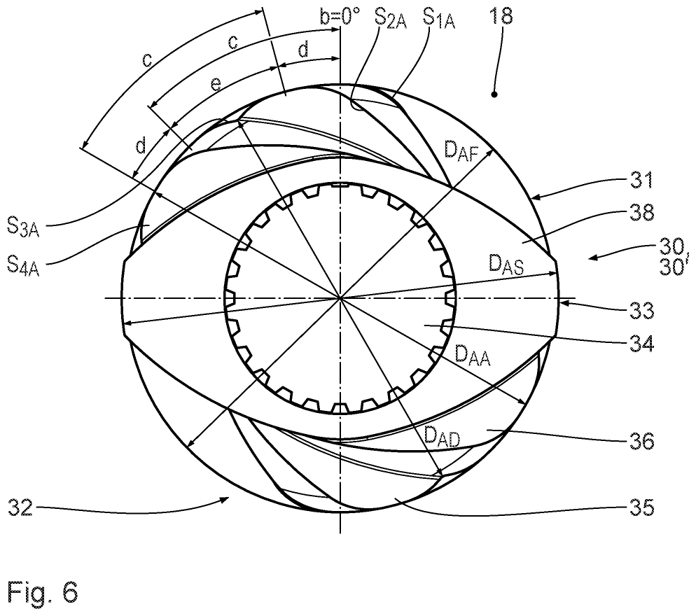

The second side S_{2F} of the conveying section 31 is connected in one piece to the first side S_{1A} of the first kneading disk 35. An offset angle b is defined between the conveying section 31 and the melting section 32, i.e. between the second side S_{2F} of the conveying section 31 and the first side S_{1A} of the first kneading disk 35, wherein the following generally applies: 0°≤b≤90°, in particular 5°≤b≤45°, and in particular 10°≤b≤15°. For the embodiment example according to FIGS. 1 to 7, the following applies by way of example: b=0°. The offset angle b is only illustrated in FIG. 6.

The first kneading disk 35 and the second kneading disk 36 are twisted. The first kneading disk 35 has a twist angle d between the sides S_{1A} and S_{2A}. Correspondingly, the second kneading disk 36 has a twist angle d between the sides S_{A3} and S_{A4}. The following generally applies to the twist angle d: 0°<d≤30°, in particular 5°≤d≤25°, and in particular 10°≤d≤20°. For the example according to FIGS. 1 to 7, the following applies by way of example: d=15°.

An offset angle c is formed between the first side S_{1A} of the first kneading disk 35 and the first side S_{3A} of the second kneading disk 36. Since the kneading disks 35, 36 have an identical twist angle d, the offset angle c is also formed between the second side S_{2A} of the first kneading disk 35 and the second side S_{4A} of the second kneading disk 36. The following generally applies to the offset angle c: 0°≤c≤90°, in particular 15°≤c≤75°, and in particular 30°≤c≤60°. For the embodiment example according to FIGS. 1 to 7, the following applies by way of example: c=45°.

Furthermore, an offset angle e is formed between the second side S_{2A} of the first kneading disk 35 and the first side S_{3A} of the second kneading disk 36. The following applies in particular to the offset angle e: e=c−d. The following applies in general to the offset angle e: 5°≤e≤70°, in particular 10°≤e≤55°, and in particular 15°≤e≤40°. For the embodiment example according to FIGS. 1 to 7, the following applies by way of example: e=30°.

The kneading disks 35, 36 have an outer diameter D_{AA} and a width L_{A} in the conveying direction 18. The outer diameter D_{AA} of the kneading disks 35, 36 can be identical and/or different. Accordingly, the width L_{A} of the kneading disks 35, 36 can be identical and/or different. For a ratio L_{A}/ D_{AA} of the width L_{A}to the outer diameter D_{AA}, the following applies in particular: 0.1≤L_{A}/ D_{AA}≤0.4, in particular 0.15≤L_{A}/ D_{AA}≤0.35, and in particular 0.2≤L_{A}/ D_{AA}≤0.3.

The kneading disks 35, 36 define a helix S_{A} due to the twist or the twist angle d. The helix S_{A} has a pitch P_{A} at one full revolution, i.e. at an angle of 360°. The pitch P_{A} is also referred to as the lead. The pitch P_{A} is merely indicated in FIG. 5. For a ratio P_{A}/D_{AA}, the following applies in particular: 5≤P_{A}/D_{AA}≤10, in particular 6≤P_{A}/D_{AA}≤9, and in particular 7≤P_{A}/D_{AA}≤8.

The supporting section 33 comprises a kneading disk 38 and a second spacer element 39. The kneading disk 38 is connected in one piece to the second spacer element 39. The kneading disk 38 is arranged downstream of the second spacer element 39 in the conveying direction 18. The kneading disk 38 comprises a first side S_{1S} which is directed upstream in the conveying direction 18, and a second side S_{2S} which is directed downstream in the conveying direction 18. The second spacer element 39 is connected in one piece to the second side S_{4A} of the kneading disk 36 and to the first side S_{1S} of the kneading disk 38.

The kneading disk 38 is untwisted or not twisted. This means that a twist angle between the first side S_{1S} and the second side S_{2S} is zero. The first side S_{1S} and the second side S_{2S} of the kneading disk 38 are thus congruent with each other in the conveying direction 18.

The kneading disk 38 has an outer diameter D_{AS} and a width L_{S} in the conveying direction 18. For a ratio L_{S}/D_{AS} of the width L_{S} to the outer diameter D_{AS}, the following applies in particular: 0.05≤L_{S}/D_{AS}≤0.5, in particular 0.1≤L_{S}/D_{AS}≤0.35, and in particular 0.15≤L_{S}/D_{AS}≤0.2.

The spacer elements 37, 39 each have an outer diameter D_{AD} and a width L_{D} in the conveying direction 18. The outer diameter D_{AD} of the spacer elements 37, 39 can be identical and/or different. Further, the width L_{D} of the spacer elements 37, 39 may be identical and/or different. For a ratio L_{D}/D_{AD} of the width L_{D} to the outer diameter D_{AD}, the following applies in particular: 0<L_{D}/D_{AD}≤0.1, and in particular 0.01≤L_{D}/D_{AD}≤0.02.

The following applies in particular: D_{AA}<D_{AS} and/or D_{AF}<D_{AS}. Furthermore, D_{AD}≤D_{AS} and/or D_{AD}≤D_{AA} and/or D_{AD}≤D_{AF} applies in particular.

The housing bores 7, 8 have a diameter D.

For a ratio D_{AF}/D applies in particular: 0.8≤D_{AF}/D<1, in particular 0.9≤D_{AF}/D≤0.99, and in particular 0.95≤D_{AF}/D≤0.98.

For a ratio D_{AA}/D, in particular: 0.8≤D_{AA}/D<1, in particular 0.9≤D_{AA}/D≤0.99, and in particular 0.95≤D_{AA}/D≤0.98.

For a ratio D_{AS}/D, in particular: 0.95≤D_{AS}/D<1, in particular 0.98≤D_{AS}/D≤0.998, and in particular 0.99≤D_{AS}/D≤0.995.

The functional principle of the apparatus 1 and the treatment elements 30, 30′ according to the invention are described below:

The material M to be processed is fed as bulk material, in particular as powder and/or granules, by means of the first dosing installation 3 through the first feed opening 16 into the multi-shaft worm machine 2. In the first feed zone 19, the material M is conveyed by means of the screw elements 28, 28′ in the conveying direction 18 to the melting zone 20.

In the melting zone 20 the material M is melted by means of the treatment elements 30, 30′ according to the invention and the kneading elements 29, 29′ arranged downstream in the conveying direction 18. To this end, the treatment elements 30, 30′ reduce the load on the shafts 26, 27, on the treatment elements 30, 30′ themselves and on the housing 6. Due to the fact that the conveying section 31 and the melting section 32 are formed in one piece with each other, the conveying section 31 and the melting section 32 are not pressed apart even under high loads, so that no gap is formed in front of the first kneading disk 35 and material M or a melt already produced from the material M could penetrate into a resulting gap. In addition, the stiffness of the treatment elements 30, 30′ is increased in the critical transition region between the conveying section 31 and the melting section 32, so that deformations and relative movements of the treatment elements 30, 30′ and the associated shafts 26, 27 are reduced. The supporting section 33, which is connected in one piece with the melting section 32, additionally reduces relative movements and deformations of the treatment elements 30, 30′. The loads on the treatment elements 30, 30′, on the shafts 26, 27 and on the housing 6 are reduced in particular in the approximate triangle regions Z. Furthermore, the load on the treatment elements 30, 30′ can be adjusted as desired via the offset angles b, c and e as well as the twist angle d, the outer diameters D_{AF}, D_{AA} and D_{AS} as well as the pitch P_{F} and P_{A} as well as the length L_{F} and the widths L_{A} and L_{S}.

In the second feed zone 21, at least one additive A is fed into the multi-shaft worm machine 2 through the second feed opening 17 by means of the second dosing installation 4. The at least one additive A is fed into the melted material M in the second feed zone 21. The melted material M and the at least one additive A are conveyed in the conveying direction 18 to the homogenizing zone 22 by means of the screw elements 28, 28′.

In the homogenizing zone 22, the at least one additive A is melted by means of the treatment elements 30, 30′ according to the invention and the kneading elements 29, 29′ arranged downstream thereof and mixed into the melted material M. The mixture is homogenized in the homogenizing zone 22. The advantages of the treatment elements 30, 30′ according to the invention correspond to the advantages of the treatment elements 30, 30′ that are arranged in the melting zone 20.

In the discharge zone 23, the homogenized mixture is discharged in the usual manner through the discharge opening 25.

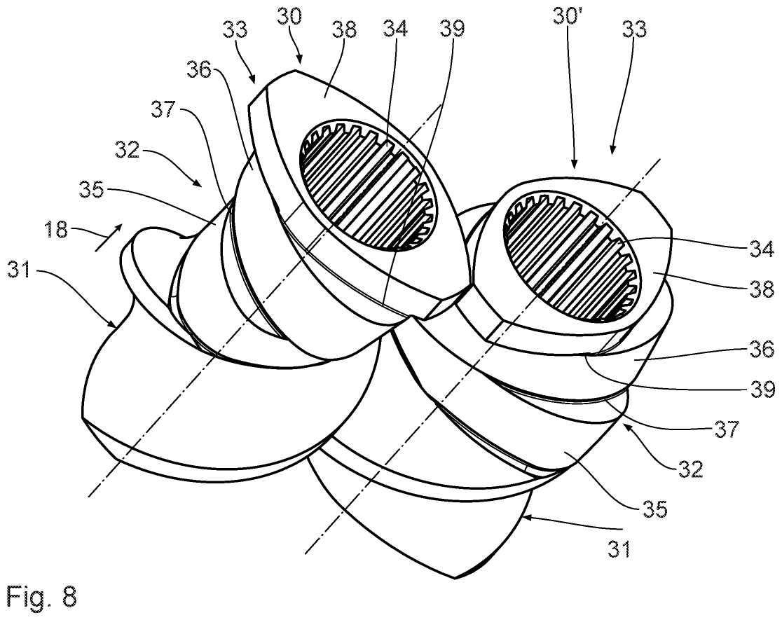

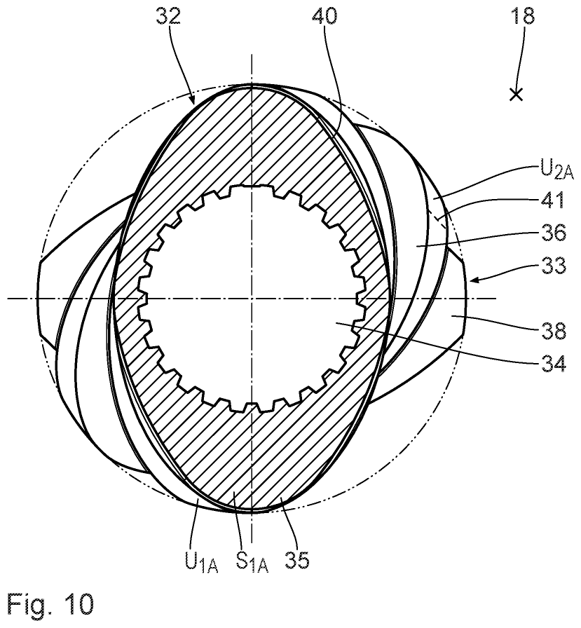

A second embodiment example of the invention is described below with reference to FIGS. 8 to 10. In contrast to the first embodiment example, the kneading disks 35, 36 of the melting section 32 have tip chamfers 40, 41. First tip chamfers 40 are formed as bevels which are arranged on the first side S_{1A} of the first kneading disk 35 and form a beveled surface between the first side S_{1A} and a circumferential side U_{1A} of the first kneading disk 35.

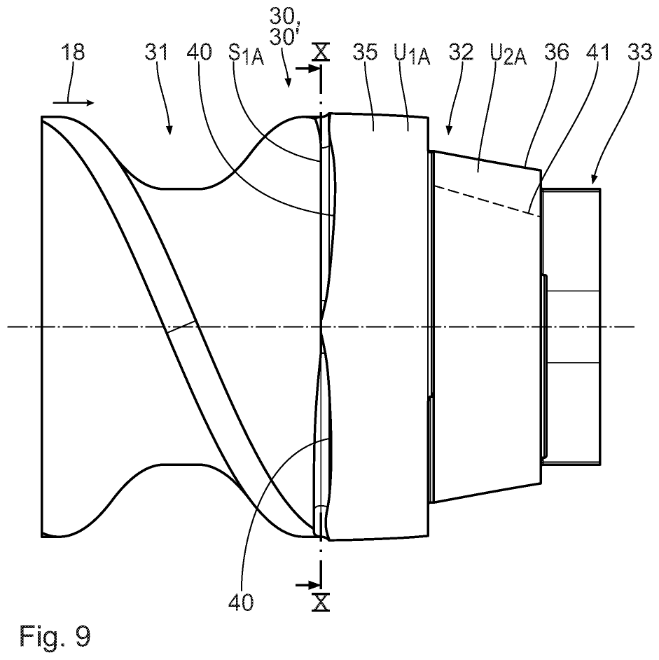

Second tip chamfers 41 are formed on the circumferential side U_{1A} of the first kneading disk 35 and on a circumferential side U_{2A} of the second kneading disk 36. Compared to the first embodiment example, the tip chamfers 41 lead to edge-free circumferential sides U_{1A} and U_{2A}. To illustrate a tip chamfer 41, a fictitious edge is drawn on the circumferential side U_{2A} in FIG. 9, which fictitious edge is actually not present due to the tip chamfer 41.

Due to the tip chamfers 40, 41, the material volume of the treatment element 30 or 30′ is reduced so that the free volume for the material M to be processed is increased in the housing bores 7, 8. This further reduces the load on the treatment elements 30, 30′, the shafts 26, 27 and the housing 6. Due to the tip chamfers 41, the kneading disks 35, 36 have an involute profile in the region of the circumferential sides U_{1A} and U_{2A}. With regard to the further structure and the functional principle, reference is made to the description of the first embodiment example.

What is claimed is:

1. A treatment element for treating material by means of a screw machine comprising
a conveying section and
a melting section,
which is arranged downstream of the conveying section in a conveying direction, and
which is connected in one piece with the conveying section.

2. The treatment element according to claim 1, wherein the melting section comprises a number N of kneading disks, wherein: 1≤N≤7.

3. The treatment element according to claim 1, wherein the melting section comprises at least two kneading disks which are arranged one after the other in the conveying direction, and at least one of a respective first side and a respective second side of the at least two kneading disks have an offset angle c relative to one another, wherein: 0°≤c≤90°.

4. The treatment element according to claim 1, wherein the melting section comprises at least one kneading disk which is twisted between a first side and a second side. The treatment element according to claim 4, wherein the at least one kneading disk has a twist angle d between the first side and the second side, wherein: 0°<d≤30°.

6. The treatment element according to claim 4, wherein the at least one kneading disk has a pitch P_{A} and an outer diameter D_{AA}, wherein: 5≤P_{A}/D_{AA}≤10.

7. The treatment element according to claim 4, wherein the melting section comprises at least two kneading disks which are arranged one after the other in the conveying direction, and a first side of a kneading disk arranged downstream has an offset angle e relative to a second side of a kneading disk arranged upstream, wherein: 5°≤e≤70°.

8. The treatment element according to claim 1, wherein the melting section comprises at least one kneading disk having a width L_{A} and an outer diameter D_{AA}, wherein: 0.1<L_{A}/D_{AA}≤0.4.

9. The treatment element according to claim 1, wherein the melting section (32) comprises at least one kneading disk having a tip chamfer.

10. The treatment element according to claim 1, wherein the conveying section has a pitch P_{F} and an outer diameter D_{AF}, wherein: 0.75≤P_{F}/D_{AF}≤2.

11. The treatment element according to claim 1, wherein the conveying section has a length L_{F} and a pitch P_{F}, wherein: 0.2≤L_{F}/P_{F}≤1.5.

12. The treatment element according to claim 1, wherein the conveying section and the melting section have an offset angle b relative to one another, wherein: 0°≤b≤90°.

13. The treatment element according to claim 1, comprising a supporting section which is arranged downstream of the melting section in the conveying direction and is connected in one piece with the melting section.

14. The treatment element according to claim 13, wherein the supporting section comprises at least one kneading disk.

15. The treatment element according to claim 14, wherein the at least one kneading disk is untwisted.

16. The treatment element according to claim 13, wherein the supporting section comprises at least one kneading disk having a width L_{S} and an outer diameter D_{AS}, wherein: 0.05≤L_{S}/D_{AS}≤0.5.

17. The treatment element according to claim 13, wherein the melting section has an outer diameter D_{AA} and the supporting section has an outer diameter D_{AS}, wherein D_{AA}<D_{AS}.

18. The treatment element according to claim 13, wherein the conveying section has an outer diameter D_{AF} and the supporting section has an outer diameter D_{AS}, wherein D_{AF}<D_{AS}.

19. A screw machine for treating material, comprising
a housing,
at least one housing bore formed in the housing, and
at least one treatment element shaft which is arranged in the at least one housing bore, wherein the at least one treatment element shaft comprises at least one treatment element according to claim 1.
